(19) United States
(12) Patent Application Publication
(10) Pub. No.: US 2005/0238145 A1
(43) Pub. Date: Oct. 27, 2005

(54) User interface for "how to use" application of automated self service call center

(75) Inventors: Benjamin A. Knott, Round Rock, TX (US); John M. Martin, Austin, TX (US); Robert R. Bushey, Cedar Park, TX (US); Michael D. Ahnemann, Newton, MA (US)

Correspondence Address: BAKER BOTTS L.L.P.;PATENT DEPARTMENT, 98 SAN JACINTO BLVD., SUITE 1500, AUSTIN, TX, 78701-4039, US

(73) Assignee: SBC Knowledge Ventures, L.P., Reno, NV (US)

(21) Appl. No.: 10/829,557

(22) Filed: Apr. 22, 2004

(51) Int. Cl. H04M 11/00; H04M 1/64

(52) U.S. Cl. 379/88.01; 379/88.16

(57) ABSTRACT

A method of providing a verbal dialog interface for a caller to an automated self-service “how to use” call system. The method uses a combination of natural language and directed dialog techniques to permit callers to hear instructions through three paths: by saying the name of a topic, by selecting the topic from a menu, or by describing the topic. A playback feature permits the caller to control the pace of presentation of the dialog. Partitioning of the dialog into modules ensures that the caller remains on track during the dialog.

### TECHNICAL FIELD OF THE INVENTION

This invention relates automated speech recognition (ASR) interfaces for self-service call center systems, and more particularly for an interface for caller's seeking “how to use” information.

### BACKGROUND OF THE INVENTION

Customer call centers are increasingly using automated self-service systems, which use voice recognition and interactive voice response techniques. Automated self-service systems are much less expensive than those using live service agents. A well designed self-service system can cost as little as 10% as a call center that uses live agents.

One type of call center service that requires unique dialog and interaction is assistance to customers who desire to learn how to use products or services. The needs of a customer who is unsure how to use a product or service tend to be more difficult to define than for other services, such as providing sales or account information. For such customers, the flow of a self service dialog is complicated to design.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIGS. 1A and 1B illustrate a “how to use” dialog in accordance with the invention.

FIG. 2 illustrates a computer implemented system for implementing the dialog of FIGS. 1A and 1B.

FIG. 3 illustrates the timeout and retry processes.

### DETAILED DESCRIPTION OF THE INVENTION

The following invention is directed to a “how to use” interface for an automated self service customer call system. For purposes of example, this description is written in terms of a “how to use” interface for telephone services, on behalf of a telephone service provider. However, the same concepts may be applied to a “how to use” interface for any type of product or service.

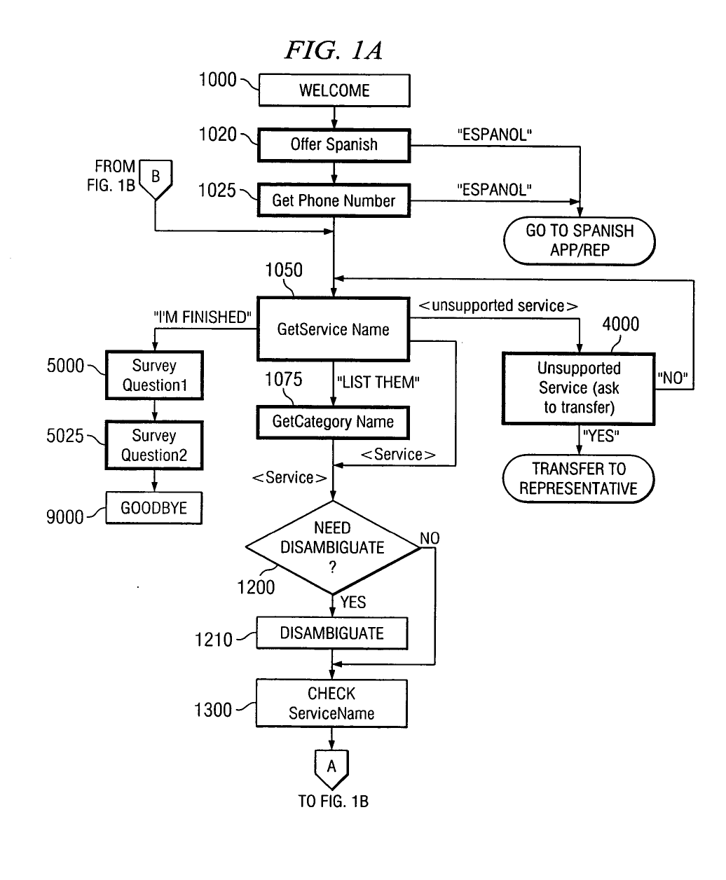

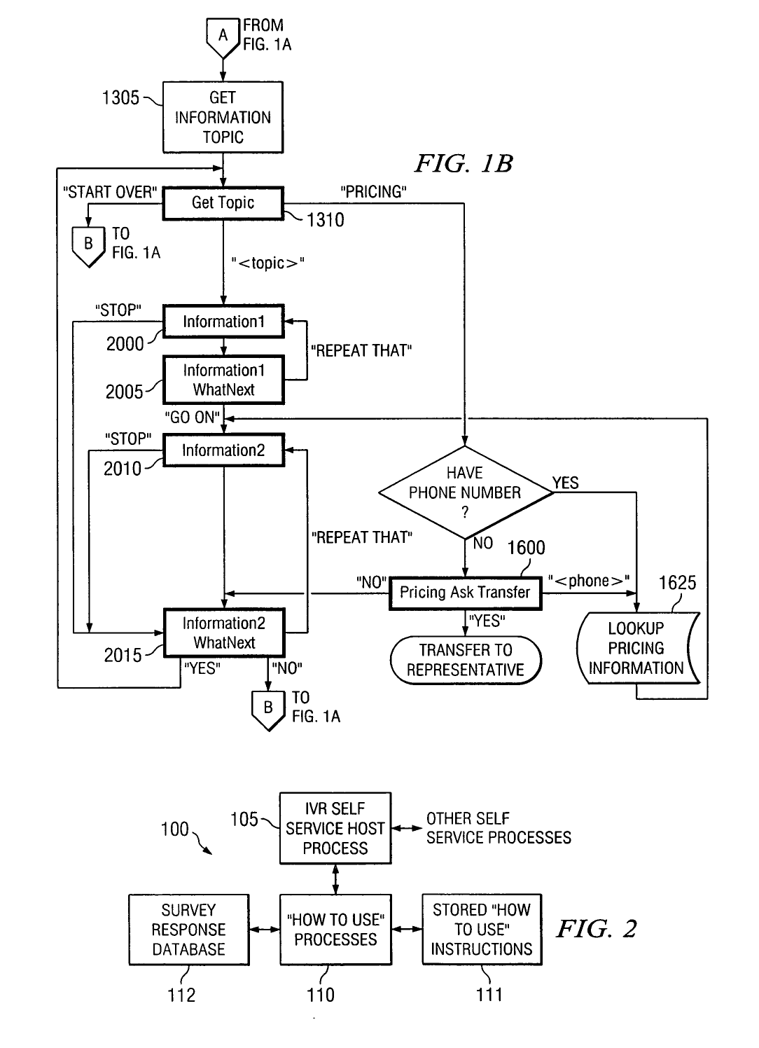

FIGS. 1A and 1B illustrate the flow of a “how to use” (HTU) dialog in accordance with the invention. A computer system for implementing the HTU dialog is described below in connection with FIG. 2.

As explained below, the system provides a caller with an interactive self-service series of verbal prompts, voice recognition entry points, and messages, the combination of which provide the caller with the desired information about how to use a selected service. Once a caller has selected a service of interest, then a topic of interest, the system provides the appropriate instructions.

As explained below in connection with FIG. 2, the dialog of FIGS. 1A and 1B is implemented using computer hardware, which is programmed in accordance with the process steps described below. The HTU system allows callers to easily access instructions for a variety of services or products within a single phone call by using speech input. The system uses a combination of natural language and directed dialog elements, allowing callers to retrieve instructions through several different paths. Specifically, callers can identify a topic of interest in three ways: by saying the name of the service or product, by selecting the topic from a menu, or by verbally describing what the service or product does in the caller's own words. This approach is achieved by using both statistical language models and grammar-based recognition techniques.

Although the dialog is especially useful for voice recognition of voice responses from the caller, it also recognizes keypad input. In some steps, keypad input is requested by prompting, such as “Enter 1 for . . . . ” or “Enter your area code and phone number”. In general, each of the caller's responses described herein could be substituted with a keypad entry, and DTMF recognition used rather than voice recognition.

Step 1000 is a Welcome state. It is a play-prompt state, and like the other play-prompt states described herein, it plays a waveform, or a series of waveforms, to the caller who hears the waveforms as a spoken message. As an example of a welcome play-prompt, the caller may hear, “Welcome to the How to Use Guide for your phone services”.

Step 1020 is an Offer Spanish interaction dialog module. Like the other interaction states described herein, Step 1020 prompts the caller for input. Interaction states also handle default timeout and retries, and typically continue to a next state upon a successful voice recognition.

An example of an Offer Spanish prompt is: “Para continuar en Espanol por favor oprima el uno”. If the caller enters “1”, the input is recognized as a DTMF signal and the call is transferred to a Spanish version of the dialog. After a pause, and if no DTMF signal is received, the dialog proceeds to Step 1025.

Step 1025 is a Get Phone Number interaction dialog module. Step 1025 typically follows Step 1020. An example of the message played in Step 1025 is: “I'll help you find out how to use any of the phone services we provide for our residential customers. To get started, I'll need your area code and home phone number. You can either say it or enter it.”

The caller then responds by speaking or entering a number. If a number is recognized, the caller is thanked and the dialog proceeds to Step 1050. If no number is recognized, various timeouts and retry messages are delivered, and upon failure of these, the dialog is exited.

Step 1050 is a Get Service Name interaction dialog module, and typically follows Step 1025. It may also be entered from Step 1310, Step 2015, or Step 4000, explained below.

When entering from Step 1025, an example of a message to the caller is: “Now, please tell me which phone service you'd like to find out about. [pause] To hear your choices, say list them”.

Natural language techniques are used so that the caller may freely speak the names of services or describe them in natural language. If the caller responds by naming or describing a service, the dialog proceeds to Step 1200. If the caller responds by speaking “List them”, the dialog proceeds to Step 1075.

If the caller has entered Step 1050 from Step 2015 or from Step 4000, the dialog speaks a message such as “If you're finished hearing about phone services, say “I'm finished”. [pause] Otherwise, . . . .” If the caller speaks “I'm finished”, the dialog proceeds to Step 5000, explained below. If the caller does not say “I'm finished”, the dialog proceeds as when entering from Step 1025.

Natural language techniques are also used to recognize when the caller has named an unsupported service. If the caller names an unsupported service, the dialog proceeds to Step 4000. Step 4000 is a process whereby the system recognizes a number of unsupported services. For example, if the caller speaks “discount packages”, the system responds with a message such as: “I'm sorry. Right now, I don't have any information about discount packages. If you want more information about this topic, you'll need to speak with a representative who can help. Would you like me to transfer you now?”. If the caller speaks “Yes”, the caller is transferred. If the caller speaks “No”, the caller returns to Step 1050, hears an appropriate message, and is given another opportunity to select a service.

Step 1075 is a Get Category Name interactive dialog module, performed if the caller has requested a list in Step 1050. An example of a message that the caller hears is: “I have the services grouped into categories based on what each service does. I'll read the categories, and when you hear the one you want, just say it. Call Answering, Caller Identification, Call Forwarding, Call Screening, Three-way Calling, Automatic Dialing, Personalized Ring, Local Plus.” The caller may then speak the name of the service category, and the dialog proceeds to Step 1200.

After the message of Step 1075, the caller is offered various retries and timeouts if there is no response or the response is not understood. Also, after a category name is spoken, the caller receives a confirmation message such as “Automatic dialing. Is that correct?”

Step 1200 is a Disambiguation Check internal decision step. If the caller has selected a service category having more than one type of service, it may be necessary to ask an additional question to determine the specific service name. Step 1200 determines whether to continue with the call dialog or to first go to a disambiguation state.

The disambiguation check of Step 1200 depends on which service the caller has selected. Some categories have only one associated service, and need no disambiguation. For those services, the dialog proceeds to Step 1300. However, other categories have more than one associated service. In this case, the dialog proceeds to Step 1210.

Step 1210 is a disambiguation process. For example, if the caller has selected the category of Automatic Dialing in Step 1050 or Step 1210, the caller might hear the following message: “There are four services that can automatically dial a number for you. Say “Auto Redial, Call Return, Speed Calling, Direct Reply, or say Help for a brief explanation of each”. The caller's response is recognized as the selected service of interest.

Step 1300 is a Check Service Name internal decision step. This state determines which of the various services the caller has asked for in Step 1050 or Step 1210, and links to a dialog module associated with that service.

Step 1310 is playing the dialog module linked in Step 1300. Each dialog module has a message that briefly describes its associated service and lists topics associated with that service.

For example, if the caller has selected the Call Notes service, the caller hears the following message: “Call Notes voicemail records a message from callers when your phone is busy or you don't answer the call. To pick a different service, say Start over. [pause] There is also a related service called Call Notes Plus, which adds a few additional features. To find out about that, say Call Notes Plus. [pause] I have several topics related to Call Notes—thirteen in fact. I'll start reading the first set of topics, and when your hear the one you want, just interrupt me and say it. [pause] Here are the first four topics. Setup, retrieve messages, change number of rings, change passcode, [pause] Was it one of these?” If the caller responds, with “Yes” or the topic name, the dialog proceeds to Step 2000. If the caller responds “No”, the dialog continues with additional topic selections.

As with other interactive steps, each of the dialog modules of Step 1310 provides the caller with various timeout and retry options, and with a confirmation message after a topic is selected. The caller may also be given an option to speak “Start over” and return to Step 1050. During or after the playing of the dialog module, the caller may say “Repeat that” to have the topics of that dialog module repeated.

Services having numerous topics may have their dialog module divided into parts, so that the caller may hear only a portion of the topics in each part of the dialog module. The example above, listing the first four topics for Call Notes is an example of such a service. The partitioning of the topics permits the dialog module to prompt for and receive the caller's request to “start over” or “Repeat that.”

A feature of Steps 1050, 1075, and 1310 is that services and topics are presented to the caller in frequency order. That is, the most frequently requested services and topics are offered to the caller first.

In Step 1310, one of the available topics may be a Pricing topic. Because pricing may depend on the caller's service location, if the caller selects the pricing topic, it is next determined whether the caller's phone number has been obtained in Step 1025.

Step 1625 is performed if the caller has selected a Pricing topic, and if the caller's phone number has been entered and recognized. In Step 1625, a database is queried and appropriate pricing information is accessed and reported to the caller. The dialog then proceeds to Step 2010.

Step 1600 is an interactive dialog module, performed if the caller has selected a Pricing topic and the caller's phone number has not been entered or recognized. In Step 1600, an example message to the caller is: “To get accurate pricing information, I'll need to transfer you to an SBC representative who can help. Would you like me to transfer you now?” If the caller responds, “Yes”, the call is transferred. If the caller responds “No”, the dialog proceeds to Step 2015. If desired, Step 1600 may include an additional message to request the caller's phone number, so that the dialog may then proceed to Step 1625.

Step 2000 is a Get Information dialog module, performed after the caller responds with a topic in Step 1310 and if the information is too lengthy to be played from a single dialog module. If the information is sufficiently short to be played in a single dialog module, the dialog proceeds directly to Step 2010.

The dialog of Step 2000 first plays a preamble message that corresponds to the topic that was chosen. For example, the message might be: “I have some instructions about how to set up call notes”. The next message provides the information to be provided to the caller for the selected topic.

After the message of Step 2000 is played, there are two possible paths for the remaining dialog. If all information has been given, the dialog proceeds to Step 2015. If the information is lengthy, it is split into more than one dialog module, and the dialog proceeds to Step 2005.

Step 2005 is a What Next voice menu module. It is performed after the information of Step 2000 has been played to the caller. This step plays a message that gives the caller the option of rehearing the information given in Step 2000 or of going on. An example message is: “Say repeat that or go on”.

As indicated above, Step 2010 is a second Get Information dialog module, and plays either the second half of information topics presented in Step 2000 or the entire information for topics that are to be played in one piece. For playing the second half of a topic, Step 2010 is performed after the caller has responded “Go on” after Step 2005. When Step 2010 is used to provide all information.

As indicated in FIG. 1B, at any point during Step 2000 or Step 2010, the caller may speak “Stop”. This causes the dialog to branch to Step 2015.

Step 2015 follows Step 2010 and is a second What Next voice menu module. If the caller has entered Step 2015 from Step 2010 and has not said “Stop”, the following message is played: “To hear that again, say Repeat That. Otherwise, . . . ”. This provides the caller with an opportunity to hear the information from Step 2010 again.

If the caller does not say “Repeat that”, the dialog asks if the caller would like more information about the particular topic selected in Step 1310. If the caller says “Yes”, the dialog returns to Step 1310. If the caller says “No”, the dialog goes to Step 1050, and continues as explained above.

Step 5000 is a voice menu step, performed when the caller says “I'm finished” during Step 1050. Step 5000 plays a first survey question, such as: “Before you go, I just want to ask you two questions about your satisfaction with this service. First, did I give you the information you were looking for?” If the caller says “Yes”, the dialog says “Great” and proceeds to Step 5025. If the caller says “No”, the dialog proceeds to Step 5025. In either case, the response is recorded.

Step 5025 is a voice menu step, performed after Step 5000. Step 5025 plays a second survey question, such as: “And rating your experience using this system on a scale from 1 to 5 with 1 being very dissatisfied and 5 being very satisfied, what's my score?”. The caller's response is recorded and the dialog goes to Step 9100. By analyzing the recorded results of Steps 5000 and 5010, the system can evaluate its effectiveness.

Step 9100 is a goodbye message. A message is played such as: Thanks for calling us. Goodbye”. The call is then ended.

The various “Repeat That” messages described above provide the caller with controllable playback, such that the caller may control the pace with which instructions are presented. Also, the division of messages into dialog modules ensures that the caller is not faced with “too much information” at once, and is given adequate opportunity to go back to a previous step or rehear a message of the present step. Each dialog has its own associated timeouts and retries, so that the caller is continually apprised of his or her position in the dialog.

Each of the above-described interactive dialog modules and voice menus includes a “Help” feature. At any time during that dialog module, the caller may say “Help”. The dialog then plays a message as specified by that dialog module. The Help feature is particularly useful during Steps 1050, 1075, and 1310, to assist the caller in identifying a topic of interest when the caller does not know the correct name of the service or product or when the caller wishes to browse topics.

FIG. 2 illustrates a computer system 100 for implementing the dialog interface of FIGS. 1A and 1B. An IVR Self Service Host process 105 is the main process for the system. It controls and passes tasks to various subsystems, one of which is the HTU process 110 of the present invention. Process 110 is programmed to perform the dialog process described above in connection with FIGS. 1A and 1B. A database 111 stores messages and instructions to be played to callers, as described above. A survey database 112 is used to store survey responses collected during the survey steps (Steps 5000 and 5025).

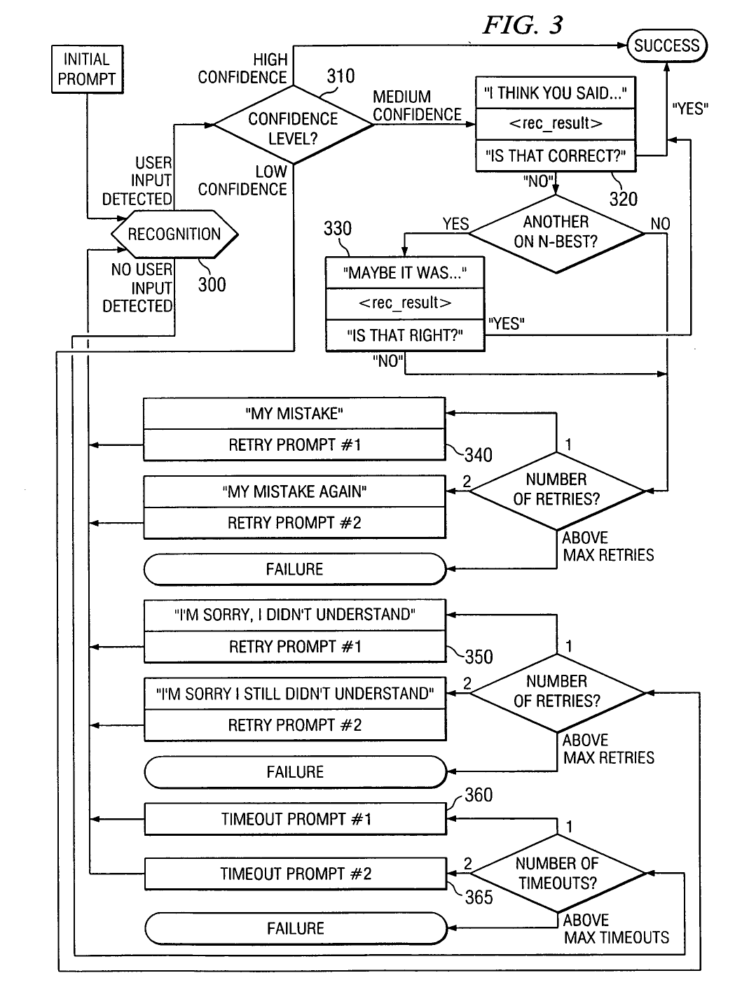

FIG. 3 illustrates the various timeout and retries included in several of the steps described above. Any one of the various interactive dialog modules described above may include these timeouts and retries.

As illustrated, after a prompt for a caller response, in Step 300, system 100 may or may not detect a response. If a response is detected, Step 310 is determining a confidence level, which may be high, medium, or low.

High confidence responses are successful voice recognition and trigger an appropriate response by system 100. Medium confidence responses are followed by a clarification message 320, which results in a successful recognition or at least one retry prompt. The message in the retry prompt depends on the associated dialog module, and is stored with other messages for that dialog module. A low confidence response is following by one or more retry messages 350. Retries are typically limited to two attempts, and if no response is recognized after that, the caller is transferred to a live agent.

If Step 300 results in no user input detected, system 100 plays one or more timeout prompts 360 and 365. The contents of the prompt depend on the particular dialog module. After a predetermined number of timeout prompts, the caller is transferred if there is no successful recognition.

A further feature of system 100 is the use of global commands. During the interactive dialog modules, the caller may at anytime by transferred to a live agent by speaking words such as” “agent”, “representative”, or “operator”. Also, the caller may return to Step 1050 by saying words such as: “start over” or “main menu”. If the caller is in Step 1210, these words return the caller to Step 1075. And as stated above, the caller may at any time speak a word such as “Help”, to which system 100 responds with a help message associated with the dialog module the caller was in.

1. A method of providing a verbal dialog interface for a caller to an automated self-service “how to use” (HTU) call system, comprising the steps of:
grouping services/products into categories;
associating one or more HTU topics with each service/product;
storing at least one HTU dialog module for each topic, such that the dialog module can be played as a voice message of HTU instructions to the caller;
wherein some topics have more two or more dialog modules, depending on the length of the instructions;
during a call from a caller, prompting the caller to name or describe a service/product or to ask for a list of services/products;
in response to the prompting step, recognizing the caller's response such that unsupported services/products are recognized and an appropriate message is played;
in response to the prompting step, if the caller asks for a list of services, providing a spoken list of categories;
in response to either the preceding prompting or providing step, recognizing the caller's response, and determining if the caller's response is to be disambiguated;
disambiguating the response by determining if the response corresponds to a category having more than one service/product, and if so, providing a list of services/products within that category, prompting the caller for a response, and recognizing the caller's response;
based on one or more of the caller's responses, recognizing the caller's selected service/product;
providing the caller with a list of topics associated with the selected service/product and recognizing the caller's selected topic; and
providing the instructions in at least one HTU dialog module associated with the selected topic, such that if the selected topic has more than one associated dialog module, the caller may request to have any selected HTU dialog module repeated;
wherein each of the above the prompting and providing steps are part of a unique dialog module associated with that step, such that each dialog module has at least one timeout process and at least one retry process.

2. A method of providing a verbal dialog interface for a caller to an automated self-service “how to use” (HTU) call system, comprising the steps of:
grouping services/products into categories;
associating one or more HTU topics with each service/product;
storing at least one HTU dialog module for each topic, such that the dialog module can be played as a voice message of HTU instructions to the caller;
wherein some topics have more two or more dialog modules, depending on the length of the instructions;
during a call from a caller, prompting the caller to name or describe a service/product or to ask for a list of services/products;
in response to the prompting step, if the caller asks for a list of services, providing a spoken list of categories;
in response to either the preceding prompting or providing step, recognizing the caller's response, and determining if the caller's response is to be disambiguated;
disambiguating the response by determining if the response corresponds to a category having more than one service/product, and if so, providing a list of services/products within that category, prompting the caller for a response, and recognizing the caller's response;
based on one or more of the caller's responses, recognizing the caller's selected service/product;
providing the caller with a list of topics associated with the selected service/product and recognizing the caller's selected topic; and
providing the instructions in at least one HTU dialog module associated with the selected topic, such that if the selected topic has more than one associated dialog module, the caller may request to have any selected HTU dialog module repeated.

3. The method of claim 2, wherein the step of prompting the caller to name or describe a service or product is preceded by a prompt for the caller's phone number.

4. The method of claim 2, wherein the dialog interface is for a telephone call system.

5. The method of claim 2, wherein the recognizing steps are performed using natural language speech recognition techniques.

6. The method of claim 2, wherein the prompting and providing steps include at least one timeout process.

7. The method of claim 2, wherein the prompting and providing steps include at least one retry process.

8. The method of claim 2, wherein in response to the step of prompting the caller to name or describe a service/product, recognizing the caller's response such that unsupported topics are also recognized and an appropriate message is played.

9. The method of claim 2, wherein the step of providing the caller with a list of topics is performed by listing the topics in order of frequency.

10. The method of claim 2, wherein the selected service is a pricing service, and of ensuring the caller's phone number is stored.

11. The method of claim 2, further comprising the step of prompting the caller for a survey response, after the step of providing the instructions.

12. The method of claim 2, wherein the prompting and providing steps include means for recognizing a spoken request for help, and of providing help information corresponding to the prompting or providing step.

13. A system for providing a verbal dialog interface for a caller to an automated self-service “how to use” (HTU) call system, comprising:
a database for storing at least the following interactive dialog modules and processes:
a Get Service Name module for prompting the caller to name or describe a service/product or to ask for a list of services/products, and for recognizing the caller's response;
a Get Category Name module for providing a list of service/product categories in response to the preceding step, and for recognizing the caller's selection from the list of categories;
a Need Disambiguation decision process for determining whether the caller has responded with a category having more than one associated service/product;
a Disambiguation process for providing a list of services/products, and for recognizing the caller's spoken selection from the list;
a Get Information process for providing the caller with a list of topics associated with a selected service/product, and for recognizing the caller's selected topic;
Information modules for providing the caller with verbal instructions associated with the selected topic;
wherein at least one topic has more than one associated Information module, based on the length of the instructions;
at least one What Next module, operable each Information module, for prompting the caller to ask for a repeat of the instructions or to command a stop, and for recognizing the caller's response; and
an interactive voice recognition system for performing the above prompting, providing, and recognizing steps.

14. The system of claim 13, further comprising at least one Survey module, operable to follow a What Next module, for prompting the caller to speak a response to a survey question, and for recognizing the caller's response.

15. The system of claim 13, wherein each module contains at least one timeout process.

16. The system of claim 13, wherein each module contains at least one retry process.

17. The system of claim 13, wherein each module is programmed to recognize the caller's spoken request for help, and to provide verbal help information corresponding to that module.

18. The system of claim 13, wherein the list of topics is presented in order of frequency.

19. The system of claim 13, further comprising an Unsupported Service module for recognizing whether the caller has spoken an unsupported service, and for providing an appropriate verbal message.

20. The system of claim 13, further comprising a Pricing module for recognizing the caller's request for pricing, and for transferring the caller to a source of pricing information.
